(19) United States
(12) Patent Application Publication
(10) Pub. No.: US 2009/0229200 A1
(43) Pub. Date: Sep. 17, 2009

(54) Photovoltaic System and Method

(76) Inventors: Robert Noble, Encinitas, CA (US); Nicol M. Zeller, La Jolla, CA (US); William S. Adelson, Ramona, CA (US); Mark Duane Colby, Temecula, CA (US); Jeffrey Ryan Labrum, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 12/046,113

(22) Filed: Mar. 11, 2008

(51) Int. Cl. E04H 14/00; E04B 1/343; E02D 27/42; F16M 11/00

(52) U.S. Cl. 52/169.13; 52/173.1; 52/745.21; 248/176.1

(57) ABSTRACT

A relocatable photovoltaic system includes a fixed anchoring system; a relocatable base removably attachable to the fixed anchoring system; and a canopy attachable to the relocatable base, the canopy including a plurality of energy converting units that convert solar energy into electrical energy.

### FIELD OF THE INVENTION

The present invention relates generally to photovoltaic systems and methods.

### BACKGROUND OF THE INVENTION

Photovoltaic systems have been devised in the past to convert solar energy to electrical energy. Some of these photovoltaic systems are designed to have a lifespan of 40-50 years and be mounted permanently to a ground foundation. A problem with this type of photovoltaic system is that some potential buyers and decision makers of this type of photovoltaic system are afraid to commit to mounting something that was designed to remain in place for 40-50 years. For example potential buyers such as universities and hospitals are not in a position to ensure that new construction would not come along during that period that would require use of the same property where the photovoltaic system(s) are located. Thus, the somewhat permanent nature of a 40-50 year photovoltaic system presents a barrier to buying for potential buyers that are not sure of the eventual use of the property where the photovoltaic system(s) is/are to be located.

### SUMMARY

Accordingly, an aspect of the invention involves the recognition that a need exists for a relocatable photovoltaic system and method that offers potential buyers and decision makers the ability to easily and inexpensively move the photovoltaic system. If the photovoltaic system is relocated to a new location, the user simply builds over (or removes) the old relocatable photovoltaic system ground mount. Thus, the relocatable photovoltaic system is appealing, leaving potential buyers of the relocatable photovoltaic system with options as to future land development.

Another aspect of the invention involves a relocatable photovoltaic system including a fixed anchoring system; a relocatable base removably attached to the fixed anchoring system; and a canopy attached to the relocatable base, the canopy including a plurality of energy converting units that convert solar energy into electrical energy.

In one or more implementations of the aspect of the invention described immediately above, the fixed anchoring system is located in the ground; the relocatable base includes an elongated vertical member and the fixed anchoring system includes a hole and a sleeve fixed in position in the hole that slidably receives the elongated vertical member of the relocatable base; the sleeve of the fixed anchoring system is vertically disposed within and coaxially located within hole; the anchoring system includes a support structure for fixing the sleeve in position in the hole, the support structure including concrete-reinforced rebar; the hole includes a vertically elongated lower section with a first diameter and a shallow upper section with a second diameter that is greater than the first diameter; the anchoring system includes a top receiver; the top receiver includes a central hole for receiving the elongated vertical member of the relocatable base there through, and threaded holes for receiving threaded bolts for attaching the relocatable base to the fixed anchoring system; a seal is provided for creating a water barrier between the relocatable base and the fixed anchoring system; the relocatable base includes a elongated vertical member with a top configured to attach with the canopy and a bottom configured to be removably attachable to the fixed anchoring system; the relocatable base includes a support structure with concrete-reinforced rebar throughout substantially an entire vertical portion of the relocatable base above the fixed anchoring system when attached to the fixed anchoring system; the relocatable base includes a support structure with concrete-reinforced rebar throughout a lower vertical portion of the relocatable base above the fixed anchoring system when attached to the fixed anchoring system; the anchoring system includes a top receiver having a recess with a geometric configuration and the relocatable base includes a bottom mounting portion with a corresponding geometric configuration that mates within the recess of the top receiver for attaching the relocatable base to the fixed anchoring system; the relocatable base includes an auxiliary power connector for supplying auxiliary power and a grid power connector for supplying grid power; the canopy is separate from, and removably attachable to, the relocatable base; the canopy includes a truss assembly, a panel mounting structure supported by the truss assembly, and one or more solar panels carried by the panel mounting structure, the one or more solar panels include a plurality of energy converting units that convert solar energy into electrical energy; the canopy is a fixed canopy that orients the one or more panels at a fixed angle where the energy converting units capture the most solar energy; and the canopy is a movable canopy that moves the one or more panels to track the relative movement of the sun through the sky so that the energy converting units capture the most solar energy.

A further aspect of the invention involves a method of using a relocatable photovoltaic system including a fixed anchoring system, a relocatable base removably attachable to the fixed anchoring system; and a canopy removably attachable to the relocatable base, the canopy including a plurality of energy converting units that convert solar energy into electrical energy. The method includes the steps of providing the fixed anchoring system including providing a hole, vertically positioning a sleeve within the hole so that the sleeve is coaxially located within the hole, connecting rebar to the sleeve, and pouring concrete into the hole to create a concrete-reinforced rebar support structure for fixing the sleeve in position within the hole, the anchoring system including a receiver at a top of the sleeve; removably attaching the relocatable base to the fixed anchoring system by lowering an elongated vertical member of the relocatable base into the sleeve so that the sleeve slidably receives the elongated vertical member, securing a bottom mounting portion of the relocatable base to the receiver; and removably attaching the canopy to the relocatable base by lowering the canopy onto a top of the relocatable base and securing the canopy to the top of the relocatable base.

A further implementation includes relocating the relocatable photovoltaic system from a prior location to a new location by providing a new fixed anchoring system at the new location; detaching and removing the canopy from relocatable base at the prior location; detaching and removing the relocatable base from the fixed anchoring system at the prior location; attaching the same relocatable base to the new fixed anchoring system at the new location; and attaching the same canopy to the relocatable base at the new location.

In a still further implementation, relocating the relocatable photovoltaic system from the prior location to the new location includes building over the fixed anchoring system at the prior location or removing the fixed anchoring system at the prior location.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a cross-sectional view of an embodiment of a relocatable photovoltaic system.

FIG. 2 is a cross-sectional view of an embodiment of an anchoring system of the relocatable photovoltaic system.

FIG. 3 is an enlarged cross-sectional view of a top portion of the anchoring system in FIG. 2 taken in area 3 of FIG. 2.

FIG. 4 is a top plan view of the ground mount in FIG. 2.

FIG. 5 is a cross-sectional view of another embodiment of a relocatable photovoltaic system.

FIG. 6 is a partial cross-sectional view of a further embodiment of a relocatable photovoltaic system.

FIG. 7 is a partial cross-sectional view of a further embodiment of a relocatable photovoltaic system.

### DETAILED DESCRIPTION

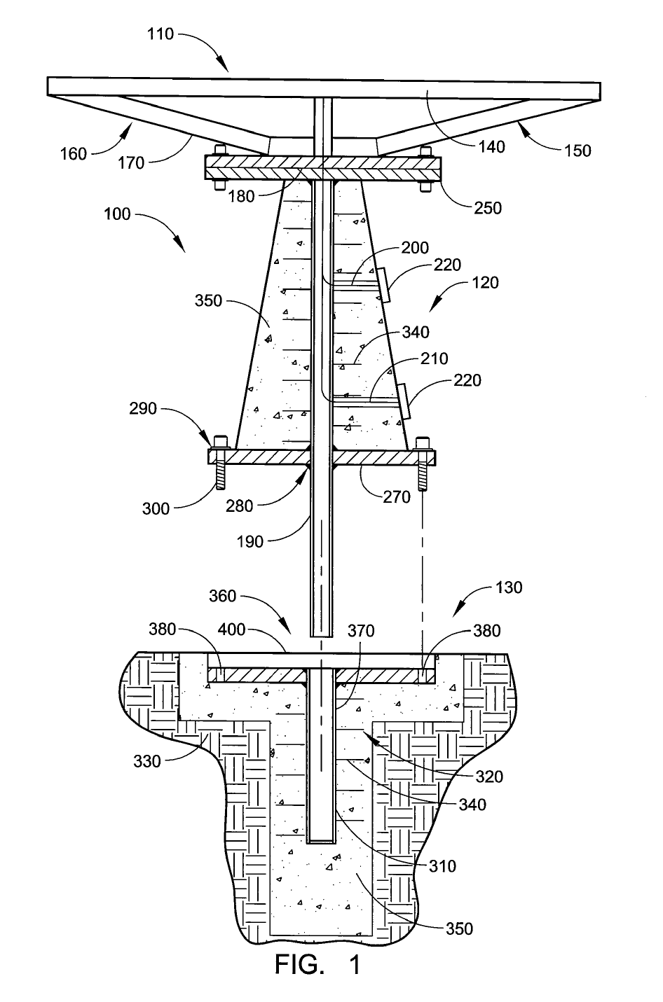

With reference to FIG. 1, an embodiment of a relocatable photovoltaic system 100 and method will be described. After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

With reference initially to FIG. 1, the relocatable photovoltaic system (“system”) 100 includes a removably attachable canopy 110, a relocatable base 120, and a fixed anchoring system 130.

The canopy 110 includes one or more solar panels 140 carried by a panel mounting structure 150. The one or more solar panels 140 include a plurality of energy converting units. In a preferred embodiment, the energy converting units are photovoltaic cells; however, in alternative embodiments, the energy converting units include, but not are not limited to, thermal-solar cells, concentrating cells, or other units that convert solar energy into electrical energy. The panel mounting structure 150 is supported by a truss assembly 160. The truss assembly 160 includes a plurality of braces 170 that stabilize the solar panel(s) 140. In an embodiment the system 100, the panel(s) 140 is/are oriented at a fixed angle where the panel(s) 140 will capture the most solar energy. Accordingly, the panel(s) may be oriented at an angle orientation other than that shown. In another embodiment, the one or more of the braces 170 of the truss assembly 160 are movable and driven by a driving/tracking mechanism to cause the solar panel(s) 140 to movably track the relative movement/path of the sun in the sky for optimizing the efficiency of the solar panel(s) 140. An example movable canopy is shown and described in corresponding U.S. patent application Ser. No. 12/025,192, filed Feb. 4, 2008, which is incorporated by reference herein as though set forth in full. The truss assembly 160 is supported by a removably attachable interface 180. The wires from the solar panel 140 may be routed down through the truss assembly 160 and a central hole of the interface 180. Alternatively, the wires may terminate at electrical connectors adjacent where the canopy 110 and base 120 interface.

In the embodiment shown, the relocatable base 120 has a frusto-pyramidal configuration; however, in alternative embodiments, the relocatable base 120 has alternative configurations such as, but not limited to, frusto-conical, parallelpiped, cubed, and cylindrical. The base 120 has a concrete trunk with an elongated vertical member in the form of a hollow steel pipe 190 longitudinally/vertically disposed in the base 120. Extending laterally from the hollow steel pipe 190 are first conduit 200 and second conduit 210. Wires are routed through the steel pipe 190 and out the first conduit 200 and the second conduit 210. The first conduit 200 terminates in an auxiliary power connector 220 for supplying auxiliary power and the second conduit 210 terminates in a grid power connector 230 for supplying grid power.

In an alternative embodiment, the base 120 and/or hollow steel pipe 190 may be pre-wired and pre-configured with the auxiliary power connector 220 and the grid power connector 230. The base 120 may include connectors near a top of the base that electrically connect to connectors of the canopy 110 adjacent where the canopy 110 and base 120 interface. This may provide a more convenient means for disconnecting/reconnecting electrical connections when the canopy 110 and base 120 are detached/connected.

A top 240 of the base 120 is capped by a steel plate or upper mount 250. A bottom 260 of the base 120 is supported by a steel plate or bottom mount 270. The bottom mount 270 includes a central hole 280 that the steel pipe 190 extends through and outer holes 290 that receive bolts 300. Although not shown, in an alternative embodiment, the bottom mount 270 may include downwardly extending pins that mate with holes in the anchoring system 130 to guide the base 120 when lowering and attaching the base 120 onto the anchoring system 130.

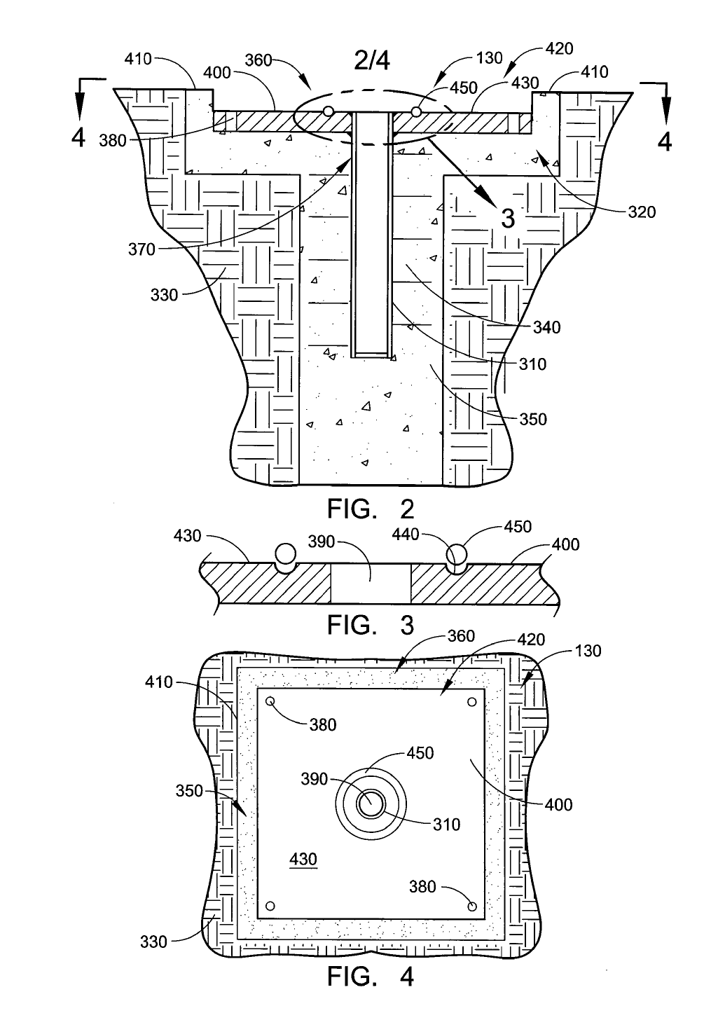

With reference additionally to FIGS. 2-4, the fixed anchoring system 130 will be described. The anchoring system 130 includes a steel sleeve 310 that slidably receives the steel pipe 190. The steel sleeve 310 is vertically disposed within and coaxially located within hole 320 in ground 330. In the embodiment shown, the hole 320 includes a vertically elongated lower section with a first diameter and a shallow upper section with a second diameter that is greater than the first diameter. The steel sleeve 310 is connected to rebar 340 and concrete 350 surrounds steel sleeve 310 and rebar 340. A receiver 360 is attached (e.g., welded) to a top 370 of the steel sleeve 310. The receiver 360 includes threaded holes 380 that threadably receive threaded portions of bolts 300 and a central hole 390 that slidably receives the steel pipe 190 there through. The receiver 360 includes a flat plate 400 circumscribed by a concrete vertical wall 410. In an alternative embodiment, the vertical wall 410 is made of steel or another metal material and is part of or connected to (e.g., welded) to flat plate 400. Together, the flat plate 400 and vertical wall 410 define a recess 420. The flat plate 400 includes an upper surface 430 with an annular recess 440 that receives an O-ring seal 450 as shown in FIGS. 2-4.

In use, the fixed anchoring system 130 is created in the ground 330. In an alternative embodiment, the fixed anchoring system 130 is created in an above-ground structure such as, but not limited to, an above-ground foundation or wall. A hole 320 having the configuration shown (e.g., vertically elongated lower section with a first diameter and a shallow upper section with a second diameter that is greater than the first diameter) is created in the ground 330. The steel sleeve 310 is vertically positioned within and coaxially located within the hole 320 and is connected to rebar 340. Concrete 350 is poured into the hole 320 and surrounds the steel sleeve 310 and rebar 340. After the concrete 350 hardens, the receiver 360 is attached (e.g., welded) to the top 370 of the steel sleeve 310. Alternatively, the receiver 360 is already part of (or pre-connected to) the sleeve 310 before the sleeve is introduced into the hole 320.

The relocatable base 120 is then anchored (removably attached) to the fixed anchoring system 130. The base 120 is moved to a position where the base 120 is vertically aligned and axially aligned with the fixed anchoring system 130. Depending on the configuration and/or weight of the base 120, this may involve using a crane or other heavy lifting equipment. The base 120 is lowered downward so that rectangular plate or bottom mount 270 aligns with and mates with the rectangular recess 420 of the receiver 360, and the steel sleeve 310 slidably receives the steel pipe 190. With the rectangular plate 270 disposed within the rectangular recess 420, relative rotation between the base 120 and the anchoring system 130 is prevented. As discussed above, in alternative embodiment, the bottom mount 270 may include downwardly extending pins that mate with holes in the anchoring system 130 to guide the base 120 when lowering and attaching the base 120 onto the anchoring system 130. The outer holes 290 of the rectangular plate or bottom mount 270 align with the threaded holes 380 of the receiver 260, and threaded bolts 300 are threadably engaged there through for anchoring the relocatable base 120 to the fixed anchoring system 130. O-ring 450 provides a seal between a bottom of the rectangular plate or bottom mount 270 and the top 370 of plate 400 of the receiver 360.

In an alternative embodiment, as shown in FIG. 7, the O-ring 450 is located on an underside of rectangular plate or bottom mount 270 in addition to (or instead of) being located on the top 370 of plate 400 of the receiver 360.

The canopy 110, which is preferably a separate assembly from the base 120, is then attached to the top of the base 120. The canopy 110 is lowered onto the base 120 (e.g., using a crane) and the interface 180 of the canopy 110 is attached to the upper mount 250 (e.g., via threaded fasteners or other attaching means) to secure the canopy 110 to the base 120. The wires from the solar panel 140 are routed through the steel pipe 190 and out the first conduit 200 and the second conduit 210. Auxiliary power connector 220 for supplying auxiliary power and grid power connector 230 for supplying grid power are electrically connected to the wires.

In an alternative embodiment, electrical connectors are provided adjacent to where the canopy 110 and base 120 interface so that the electrical connection between the solar panel 140 and the auxiliary power connector 220 and the grid power connector 230 may be connected at a more convenient location when the canopy 110 and base 120 are connected or re-connected.

To relocate the relocatable photovoltaic system 100, a new fixed anchoring system 130 is provided at a new location. Then, the canopy 110 is detached from base 120 (e.g., by removing threaded fasteners securing the interface 180 and the upper mount 250) and removed (e.g., lifted) from the base 120. Before this step, the auxiliary power connector 220 and the grid power connector 230 may be disconnected from the solar panel wires so that the wires can be removed from the hollow steel pipe 190.

In the alternative embodiment described above where the base 120 is pre-wired and electrical connectors are provided adjacent to where the canopy 110 and base 120 interface, the auxiliary power connector 220 and the grid power connector 230 do not need to be disconnected from the solar panel wires and the wires removed from the base 120. The connectors adjacent to the interface between the canopy 110 and the base 120 are simply disconnected.

The base 120 is then detached from the fixed anchoring system 130 (e.g., by removing threaded bolts 300 from the rectangular plate or bottom mount 270 and the receiver 360) and removed (e.g., lifted) from the fixed anchoring system 130. The base 120 is then attached to the new fixed anchoring system 130 at the new location in a manner similar to that described above. Then, the canopy is 110 is re-attached to the top of the base 120 in a manner similar to that described above. With the relocatable photovoltaic system 100 relocated to a new location, the old anchoring system 130 can simply be built over or removed at the old photovoltaic system location.

In an alternative embodiment, the canopy 110 and the base 120 are integrated into a single assembly instead of two separate removably attachable assemblies. In such an embodiment, the combined canopy 110 and base 120 form a single assembly that is lowered onto and attached to the anchoring system 130, and may later be detached/lifted from the anchoring system 130 as a single assembly.

Thus, the relocatable photovoltaic system 100 and method offers potential buyers of the photovoltaic system the ability to easily and inexpensively move the photovoltaic system. If the photovoltaic system is relocated to a new location, the user simply builds over (or removes) the old anchoring system 130. Thus, the relocatable photovoltaic system is appealing to potential buyers because it allows for options as to future land development.

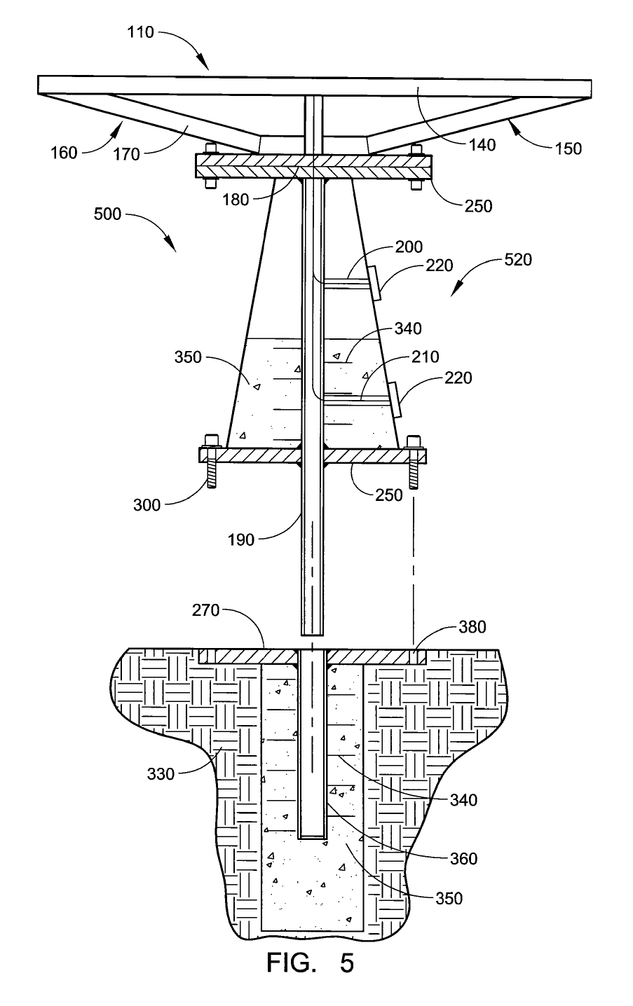

With reference to FIG. 5, another embodiment of a relocatable photovoltaic system 500 is shown. The relocatable photovoltaic system 500 is similar to the relocatable photovoltaic system 100 described above, except instead of substantially all of the vertical portion of the base 120 being reinforced with concrete, only approximately the bottom ⅓ (e.g., lower 3-4 ft) of the base 520 is reinforced with concrete since this is the area where the stress loads are the greatest on the base 520. This design also lightens the base 520, uses less material, and allows the use of faux facades on the outside of the base 520, especially the upper ⅔ of the base 520. The faux facades can be used to match the surrounding buildings or to add artistic appeal to the relocatable photovoltaic system 500. The base 520 in FIG. 5 would be ideal for applications that call for creative flexibility in the choice of cladding materials, compared to the base 120 in FIG. 1, which would be ideal for situations when a uniform concrete finish, as well as the added durability of a monolithic concrete column are desired.

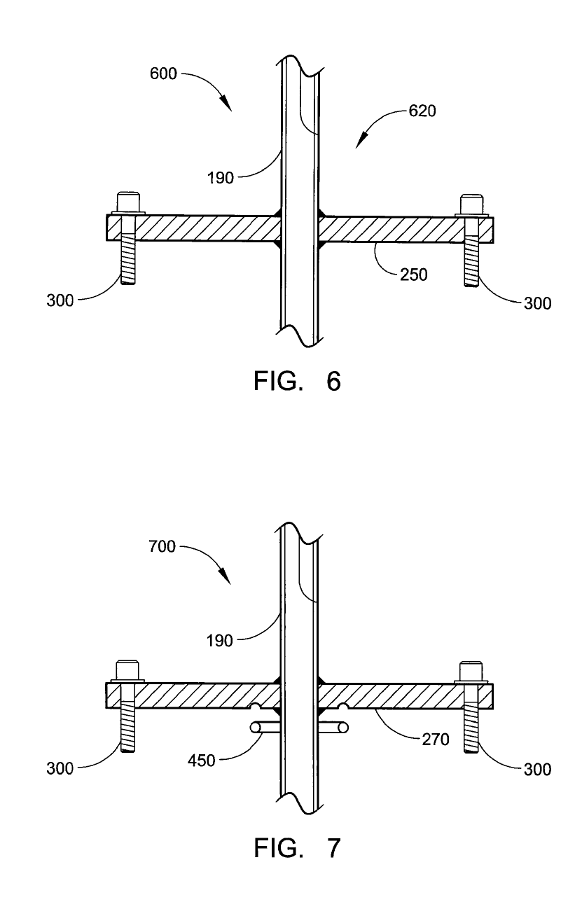

With reference to FIG. 6, a further embodiment of a relocatable photovoltaic system 600 is shown. The relocatable photovoltaic system 600 is similar to the relocatable photovoltaic systems 100, 500 described above, except instead of a concrete base 120, 520 with, for example, a frusto-pyramidal configuration, hollow steel pipe 190 forms the base 620. This design lightens the base and uses less material. The base 620 of FIG. 6 would be ideal for projects where a pre-engineered concrete base or concrete column are not desired, such as to utilize unique cladding materials or to maintain the aesthetic of an un-clad steel column.

With reference to FIG. 7, a further embodiment of a relocatable photovoltaic system 700 is shown. The relocatable photovoltaic system 700 is similar to the relocatable photovoltaic systems 100, 500, 600 described above, except the O-ring 450 is located on an underside of rectangular plate or bottom mount 270 in addition to (or instead of) being located on the top 370 of plate 400 of the receiver 360 of the anchoring system 130. The relocatable photovoltaic system 700 may include any of the base designs described above or a different base design.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A relocatable photovoltaic system, comprising:
a fixed anchoring system;
a relocatable base removably attached to the fixed anchoring system;
a canopy attached to the relocatable base, the canopy including a plurality of energy converting units that convert solar energy into electrical energy.

2. The relocatable photovoltaic system of claim 1, wherein the fixed anchoring system is located in the ground.

3. The relocatable photovoltaic system of claim 1, wherein the relocatable base includes an elongated vertical member and the fixed anchoring system includes a hole and a sleeve fixed in position in the hole that slidably receives the elongated vertical member of the relocatable base.

4. The relocatable photovoltaic system of claim 3, wherein the sleeve of the fixed anchoring system is vertically disposed within and coaxially located within hole.

5. The relocatable photovoltaic system of claim 4, wherein the anchoring system includes a support structure for fixing the sleeve in position in the hole, the support structure including concrete-reinforced rebar.

6. The relocatable photovoltaic system of claim 4, wherein the hole includes a vertically elongated lower section with a first diameter and a shallow upper section with a second diameter that is greater than the first diameter.

7. The relocatable photovoltaic system of claim 4, wherein the anchoring system includes a top receiver.

8. The relocatable photovoltaic system of claim 7, wherein the top receiver includes a central hole for receiving the elongated vertical member of the relocatable base there through, and threaded holes for receiving threaded bolts for attaching the relocatable base to the fixed anchoring system.

9. The relocatable photovoltaic system of claim 7, further including a seal for creating a water barrier between the relocatable base and the fixed anchoring system.

10. The relocatable photovoltaic system of claim 1, wherein the relocatable base includes a elongated vertical member with a top configured to attach with the canopy and a bottom configured to be removably attachable to the fixed anchoring system.

11. The relocatable photovoltaic system of claim 1, wherein the relocatable base includes a support structure with concrete-reinforced rebar throughout substantially an entire vertical portion of the relocatable base above the fixed anchoring system when attached to the fixed anchoring system.

12. The relocatable photovoltaic system of claim 1, wherein the relocatable base includes a support structure with concrete-reinforced rebar throughout a lower vertical portion of the relocatable base above the fixed anchoring system when attached to the fixed anchoring system.

13. The relocatable photovoltaic system of claim 1, wherein the anchoring system includes a top receiver having a recess with a geometric configuration and the relocatable base includes a bottom mounting portion with a corresponding geometric configuration that mates within the recess of the top receiver for attaching the relocatable base to the fixed anchoring system, and prevent relative rotation there between.

14. The relocatable photovoltaic system of claim 1, wherein the relocatable base includes an auxiliary power connector for supplying auxiliary power and a grid power connector for supplying grid power.

15. The relocatable photovoltaic system of claim 1, wherein the canopy is separate from, and removably attachable to, the relocatable base.

16. The relocatable photovoltaic system of claim 1, wherein the canopy includes a truss assembly, a panel mounting structure supported by the truss assembly, and one or more solar panels carried by the panel mounting structure, the one or more solar panels include a plurality of energy converting units that convert solar energy into electrical energy.

17. The relocatable photovoltaic system of claim 16, wherein the canopy is a fixed canopy that orients the one or more panels at a fixed angle where the energy converting units capture the most solar energy.

18. The relocatable photovoltaic system of claim 16, wherein the canopy is a movable canopy that moves the one or more panels to track the relative movement of the sun through the sky so that the energy converting units capture the most solar energy.

19. A method of using a relocatable photovoltaic system including a fixed anchoring system, a relocatable base removably attachable to the fixed anchoring system; and a canopy removably attachable to the relocatable base, the canopy including a plurality of energy converting units that convert solar energy into electrical energy, the method comprising:
providing the fixed anchoring system including providing a hole, vertically positioning a sleeve within the hole so that the sleeve is coaxially located within the hole, connecting rebar to the sleeve, and pouring concrete into the hole to create a concrete-reinforced rebar support structure for fixing the sleeve in position within the hole, the anchoring system including a receiver at a top of the sleeve;
removably attaching the relocatable base to the fixed anchoring system by lowering an elongated vertical member of the relocatable base into the sleeve so that the sleeve slidably receives the elongated vertical member, securing a bottom mounting portion of the relocatable base to the receiver;
removably attaching the canopy to the relocatable base by lowering the canopy onto a top of the relocatable base and securing the canopy to the top of the relocatable base.

20. The method of claim 19, further including relocating the relocatable photovoltaic system from a prior location to a new location by providing a new fixed anchoring system at the new location;
detaching and removing the canopy from the relocatable base at the prior location;
detaching and removing the relocatable base from the fixed anchoring system at the prior location;
attaching the same relocatable base to the new fixed anchoring system at the new location;
attaching the same canopy to the relocatable base at the new location.

21. The method of claim 20, further including, after relocating the relocatable photovoltaic system from the prior location to the new location, building over the fixed anchoring system at the prior location or removing the fixed anchoring system at the prior location.
